(19) United States
(12) Patent Application Publication
(10) Pub. No.: US 2007/0116274 A1
(43) Pub. Date: May 24, 2007

(54) TERMINAL, METHOD AND COMPUTER PROGRAM PRODUCT FOR RECORDING BROADCAST CONTENT

(75) Inventors: Kari Matilainen, Jaali (FI); Maria Uusiltalo, Kempele (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/554,285

(22) Filed: Oct. 30, 2006

Related U.S. Application Data
(60) Provisional application No. 60/732,042, filed on Nov. 1, 2005.

(51) Int. Cl. H04L 9/00

(52) U.S. Cl. 380/42

(57) ABSTRACT

A terminal for recording broadcast content includes a processor configured for receiving broadcast content for a selected channel, and a user input interface. The user input interface includes a key configured for performing a first function in response to a first manner of depressing the key, where the same key is also preprogrammed for performing a second, different function in response to a second manner of depressing the key. The first function comprises recording content for the selected channel. As such, the processor is also configured for recording content for the selected channel in response to a user depressing the key of the user input interface in the first manner.

### CROSS REFERENCE TO RELATED APPLICATION(S)

This application claims the benefit of U.S. Provisional Patent Application No. 60/732,042, entitled: Terminal, Method and Computer Program Product for Recording Broadcast Content, and filed Nov. 1, 2005, the content of which is incorporated herein in its entirety.

### FIELD OF THE INVENTION

Embodiments of the present invention generally relate to systems and methods for providing broadcast content and, more particularly, to terminals, methods and computer program products for recording broadcast content.

### BACKGROUND OF THE INVENTION

The deployment of advanced high bit-rate mobile networks has opened up new opportunities for delivering a host of services in a way that was not possible with earlier second generation wireless networks. Recent systems including third generation (3G) systems, such as those specified for use with the Global System for Mobile Communications (GSM) wireless standard, enable the delivery of new digital services such as video calls and the playback of multimedia applications that are comprised of audio and video clips. In this regard, the increased bit rates of 3G systems widen the possibilities for providing digital services.

The increased bit rates of 3G systems provide adequate performance for delivering high quality digital audio and acceptable quality moving image clips or videos as an example of point-to-point data delivery mechanisms. One such delivery technique that has shown promise is Digital Video Broadcasting (DVB). In this regard, DVB-T, which is related to DVB-C (cable) and DVB-S (satellite), is the terrestrial variant of the DVB standard. As is well known, DVB-T is a wireless point-to-multipoint data delivery mechanism developed for digital TV broadcasting, and is based on the MPEG-2 transport stream for the transmission of video and synchronized audio. DVB-T has the capability of efficiently and simultaneously transmitting large amounts of data over a broadcast channel to a high number of users. DVB-H (handheld), which is also related to DVB-T, can provide such increased performance particularly for wireless data delivery to handheld devices.

Digital broadband data broadcast networks are known. As mentioned, an example of such a network enjoying popularity in Europe and elsewhere world-wide is DVB which, in addition to the delivery of television content, is capable of delivering data, such as Internet Protocol (IP) data. Other examples of broadband data broadcast networks include Japanese Terrestrial Integrated Service Digital Broadcasting (ISDB-T), Digital Audio Broadcasting (DAB), Digital Multimedia Broadcasting (DMB) and MBMS, and those networks provided by the Advanced Television Systems Committee (ATSC). In many such systems, a containerization technique is utilized in which content for transmission is placed into MPEG-2 packets which act as data containers. Thus, the containers can be utilized to transport any suitably digitized data including, but not limited to High Definition TV, multiple channel Standard definition TV (PAUNTSC or SECAM) and, of course, broadband multimedia data and interactive services.

The combined use of mobile telecommunications with a broadband delivery technique such as DVB-T has been proposed in the past in order to achieve efficient delivery of digital services to users on the move. This would take advantage of existing infrastructures in the effort to provide personal communications (already prevalent) and the growing demand for Internet access, together with the expected rise of digital broadcasting, so that users can receive these services with a single device. Furthermore, DVB-T is a cross platform standard that is shared by many countries thereby making frequency compatibility and roaming less of an issue. The combination of mobile telecommunication and relatively very low cost digital broadband delivery techniques provides the possibility of interactive services such as uni-directional and bidirectional services such as audio and video streaming (e.g., TV, radio, etc.), file downloads and advanced gaming applications, etc.

It is contemplated that digital broadband data broadcast networks will be used to broadcast content for one or more television, radio and/or data channels. For example, it is contemplated that mobile television DVB-H broadcasts will include content for 10-50 or more television channels. In various instances, such content is broadcast in bursts each of which includes time-sliced content for a plurality of channels. This broadcasting of channels in time slices achieves power saving in mobile devices by permitting such devices to power up to receive a burst of time-sliced content for a number of channels, and then power down for the longer time period between bursts.

As will be appreciated, when a user operates a terminal to consume or otherwise view broadcast content for a particular channel, the user may desire to direct their terminal to perform one or more other functions, such as to place or answer a call. A number of conventional content broadcasting techniques, however, may require the user to choose between consuming the broadcast content and performance of other functions, thereby requiring a user to forego consumption of broadcast content should the user choose to perform other functions. In an effort to permit the user to both consume the broadcast content and perform other functions, techniques have been developed whereby the user may direct the terminal to record broadcast content for later consumption. A number of those techniques, however, may require the user to navigate through a series of menus to direct the terminal to record the desired content. Further, a number of those techniques may be undesirably burdensome on terminals, such as mobile terminals, having limited memory resources for storing recorded content.

### SUMMARY OF THE INVENTION

In light of the foregoing background, exemplary embodiments of the present invention provide an improved terminal, method and computer program product for recording content. Exemplary embodiments of the present invention provide a terminal including one or more keys capable of being preprogrammed for performing one or more functions of the terminal, and also configured for recording broadcast content. For example, one or more such keys preprogrammed for actuating the mobile station to perform one or more predefined functions may also be configured for actuating a client application, such as a mobile TV application, to record content for a selected channel x of a plurality of channels.

According to one aspect of embodiments of the present invention, a terminal is provided for recording broadcast content. The terminal includes a processor configured for receiving broadcast content for a selected channel, and a user input interface. The user input interface includes a key configured for performing a first function in response to a first manner of depressing the key, where the same key is also preprogrammed for performing a second, different function in response to a second manner of depressing the key. The first function comprises recording content for the selected channel and the second function may comprise, for example, placing or answering a call at the terminal. The processor is therefore also configured for recording content for the selected channel in response to a user depressing the key of the user input interface in the first manner.

The processor may be further configured for performing the second function in response to the user depressing the key of the user input interface in the second manner. The first manner of depressing the key may be the same as or different from the second manner of depressing the key. When the first and second manners are the same, the processor may be further configured for performing the second function in response to the user depressing the key of the user input interface in the first manner.

The processor may also be configured for consuming (e.g., displaying) the broadcast content as the broadcast content is received. In such instances, the processor may be configured for at least temporarily ceasing consumption of the broadcast content as the second function is performed. Further, the processor may be configured for directing a remote network entity (e.g., set top box) to record content for the selected channel, such as in a manner via or independent from the terminal.

Other aspects of embodiments of the present invention provide a method and computer program product for recording broadcast content. Exemplary embodiments of the present invention therefore provide an improved terminal, method and computer program product for recording content. As explained indicated above and explained below, the terminal, method and computer program product of exemplary embodiments of the present invention may solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one exemplary embodiment of the present invention including a cellular network and a data network to which a terminal is bi-directionally coupled through wireless RF links;

FIG. 2 is a schematic block diagram of an entity capable of operating as a terminal, origin server, digital broadcast receiving terminal and/or a digital broadcaster, in accordance with exemplary embodiments of the present invention;

FIG. 3 is a functional block diagram of a digital broadcast receiving terminal, in accordance with one exemplary embodiment of the present invention;

FIG. 4 is a functional block diagram of the digital broadcaster, in accordance with one exemplary embodiment of the present invention;

FIG. 5 is a schematic illustration of ordered channels of broadcast content, in accordance with one exemplary embodiment of the present invention;

FIGS. 6 and 7 are a functional block diagram and a schematic diagram, respectively, of a mobile station that may operate as a terminal, according to exemplary embodiments of the present invention;

FIG. 8 is a flowchart illustrating various steps in a method of configuring actuation of a client application to record broadcast content for a selected channel in response to depressing one or more preprogrammed keys of a user input interface of a terminal, in accordance with one exemplary embodiment of the present invention;

FIG. 9 is a functional block diagram of a terminal receiving broadcast content for one or more channels of a set of channels, in accordance with exemplary embodiments of the present invention; and

FIG. 10 is a flowchart illustrating various steps in a method of recording broadcast content for a selected channel, in accordance with one exemplary embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

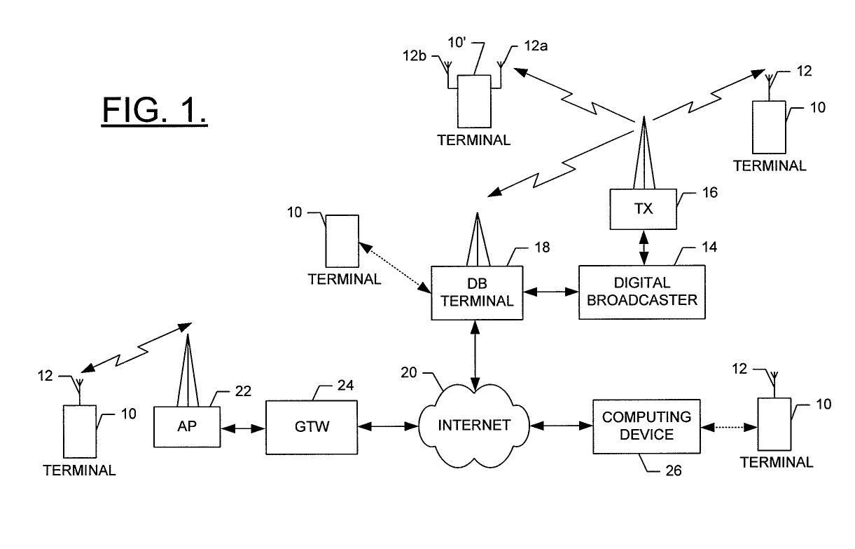

Referring to FIG. 1, an illustration of one type of terminal and system that would benefit from the present invention is provided, the terminal being capable of communicating within and/or across one or more mobile and/or fixed networks. As shown, a terminal 10 may include an antenna 12 for transmitting signals to and for receiving signals from a digital broadcaster 14 via a digital broadcast network, such as a terrestrial digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX) 16, such as a DVB TX. Similarly, the terminal can include a receiver, such as a DVB-H receiver (not shown). The terminal can be capable of receiving content from any of a number of different entities in any one or more of a different number of manners. In one embodiment, for example, the terminal can comprise a terminal 10′ capable of transmitting and/or receiving data, content or the like in accordance with a DVB (e.g., DVB-T, DVB-H, etc.) technique. In such an embodiment, the terminal 10′ may include an antenna 12a for receiving content from the DVB TX, and another antenna 12b for transmitting signals to and for receiving signals from a base site or base station (BS) of a cellular network (not shown). For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling the terminal 10 to the digital broadcaster 14 via the TX 16, the terminal can be coupled to a digital broadcast (DB) receiving terminal 18 which, in turn, can be coupled to the digital broadcaster, such as directly and/or via the TX. In such instances, the digital broadcast receiving terminal can comprise a DVB receiver, such as a DVB receiver in the form of a set top box. The terminal can be locally coupled to the digital broadcast receiving terminal, such as via a personal area network. In one exemplary embodiment, however, the terminal can additionally or alternatively be indirectly coupled to the digital broadcast receiving terminal via a data network, such as a local area network (LAN), a metropolitan area network (MAN), and/or a wide area network (WAN) like the Internet 20. The terminal can be directly coupled to the Internet, or indirectly coupled to the Internet. For example, the terminal can be coupled to the Internet, and thus the digital broadcast receiving terminal, via a wireless access point (AP) 22 and/or a gateway (GTW) 24. Additionally or alternatively, the terminal can be coupled to the Internet via one or more other computing devices 26, such as personal computers, server computers or the like. In such instances, the terminal can be coupled to an AP and/or computing device in accordance with any of a number of different techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like.

Although not every element of every possible network is shown and described herein, it should be appreciated that the terminal 10 can be coupled to one or more of any of a number of different networks including, as indicated above, one or more cellular networks. In this regard, one or more networks can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

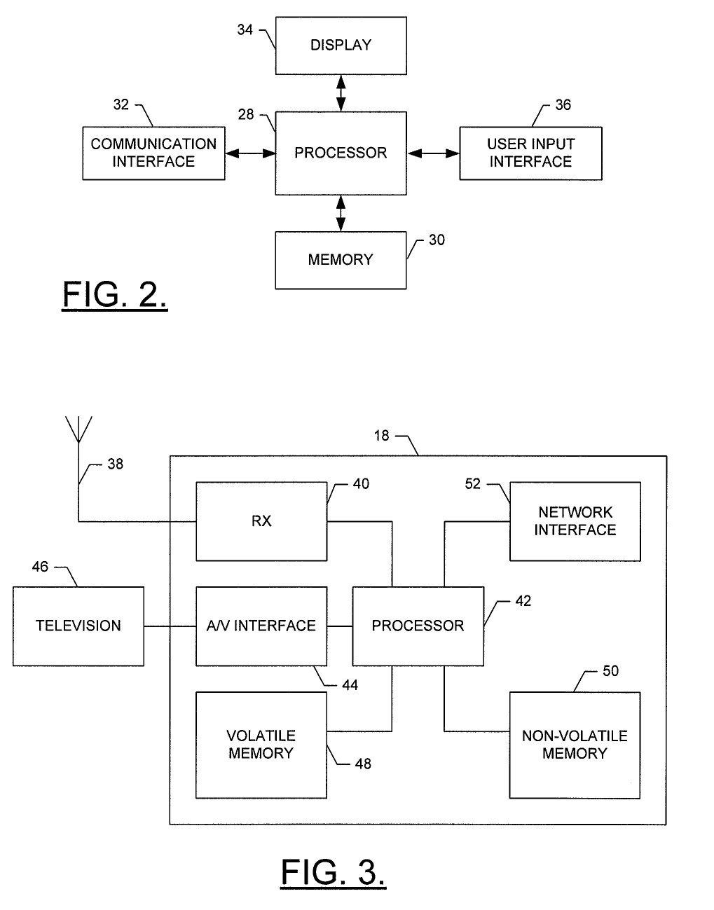

Referring now to FIG. 2, a block diagram of an entity capable of operating as a terminal 10, digital broadcaster 14 and/or digital broadcast receiving terminal 18 is shown in accordance with one embodiment of the present invention. Although shown as separate entities, in some embodiments, one or more entities may support one or more of a terminal, digital broadcaster and/or digital broadcast receiving terminal, logically separated but co-located within the entit(ies). For example, a single entity may support a logically separate, but co-located, terminal and digital broadcast receiving terminal. Also, for example, a single entity may support a logically separate, but co-located digital broadcast receiving terminal and digital broadcaster.

The entity capable of operating as a terminal 10, digital broadcaster 14 and/or digital broadcast receiving terminal 18 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 28 connected to a memory 30. The memory can comprise volatile and/or non-volatile memory, and stores content, data or the like. For example, the memory stores content transmitted from, and/or received by, the entity. Also for example, the memory stores client applications, instructions or the like for the processor to perform steps associated with operation of the entity in accordance with exemplary embodiments of the present invention. As explained below, for example, the memory can store client application(s), such as a conventional text viewer, audio player, video player, multimedia viewer or the like, for consuming content for one or more television, radio and/or data channels.

Also, for example, the memory 30 can store a digital rights management (DRM) engine integral or otherwise in communication with one or more client application(s) such that the DRM engine can control the consumption of content based upon a DRM technique. Such a DRM engine may be configured in accordance with any of a number of different DRM techniques including, for example, that defined by the Open Mobile Alliance (OMA) Digital Rights Management specification. Further, the memory can store a decryption module integral or otherwise in communication with one or more client application(s) and the DRM engine such that the encryption/decryption module can encrypt content for consumption by the client application(s). In this regard, the decryption module can be configured to decrypt content in accordance with any of a number of different techniques by which the content is encrypted including, for example, Internet Protocol Security (IPSec), Secure Real Time Transport Protocol (SRTP) or the like.

As described herein, the client application(s), DRM engine and decryption module each comprise software operated by the respective entities. It should be understood, however, that any one or more of the client applications, DRM engine and decryption module described herein can alternatively comprise firmware or hardware, without departing from the spirit and scope of the present invention. Generally, then, the terminal 10, digital broadcaster 14 and/or digital broadcast receiving terminal 18 can include one or more logic elements for performing various functions of one or more client application(s), DRM engine and/or decryption module. As will be appreciated, the logic elements can be embodied in any of a number of different manners. In this regard, the logic elements performing the functions of one or more client applications, DRM engine and/or decryption module can be embodied in an integrated circuit assembly including one or more integrated circuits integral or otherwise in communication with a respective network entity (i.e., terminal, origin server, digital broadcast receiving terminal, digital broadcaster, etc.) or more particularly, for example, a processor 28 of the respective network entity. The design of integrated circuits is by and large a highly automated process. In this regard, complex and powerful software tools are available for converting a logic level design into a semiconductor circuit design ready to be etched and formed on a semiconductor substrate. These software tools, such as those provided by Avant! Corporation of Fremont, Calif. and Cadence Design, of San Jose, Calif., automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 30, the processor 28 can also be connected to at least one interface or other means for displaying, transmitting and/or receiving data, content or the like. In this regard, the interface(s) can include at least one communication interface 32 or other means for transmitting and/or receiving data, content or the like, as well as at least one user interface that can include a display 34 and/or a user input interface 36. The user input interface, in turn, can comprise any of a number of devices allowing the entity to receive data from a user, such as a keypad, a touch display, a joystick, an image capture device (e.g., digital camera) or other input device. More particularly, for example, the user input interface can include one or more directional keys (hard and/or soft keys) for directionally selecting ordered items, such as ordered channels of content. Also, for example, the user input interface can include a key (hard and/or soft key) for actuating the image capture device.

Reference is now made to FIG. 3, which illustrates a functional block diagram of a digital broadcast receiving terminal 18, in accordance with one embodiment of the present invention. As shown, the digital broadcast receiving terminal includes an antenna 38 for receiving signals from a digital broadcaster 14 and feeding the signals into a receiver (RX) 40. In turn, the receiver is capable of decrypting, demodulating and/or demultiplexing the signals, such as to extract content data. The receiver can feed the content data to a processor 42, which can thereafter decode the content data. The processor can then feed the decoded signal into an audio/video (A/V) interface 44, which can convert signals to a form suitable for display by a monitor, such as a television set 46.

The digital broadcast receiving terminal 18 can include volatile memory 48, such as volatile Random Access Memory (RAM) including a cache area for the temporary storage of data. The digital broadcast receiving terminal can also include non-volatile memory 50, which can be embedded and/or may be removable. The non-volatile memory can additionally or alternatively comprise an EEPROM, flash memory, hard disk or the like. The memories can store any of a number of pieces of information, content and data, used by the digital broadcast receiving terminal to implement the functions of the digital broadcast receiving terminal. For example, as indicated above, the memories can store content, such as that received from a digital broadcaster 14.

The digital broadcast receiving terminal 18 can also include one or more interface means for sharing and/or obtaining data from electronic devices, such as terminals 10 and/or digital broadcasters 14. More particularly, the digital broadcast receiving terminal can include a network interface means 52, for sharing and/or obtaining data from a network, such as the Internet 20. For example, the digital broadcast receiving terminal can include an Ethernet Personal Computer Memory Card International Association (PCMCIA) card configured to transmit and/or receive data to and from a network, such as the Internet.

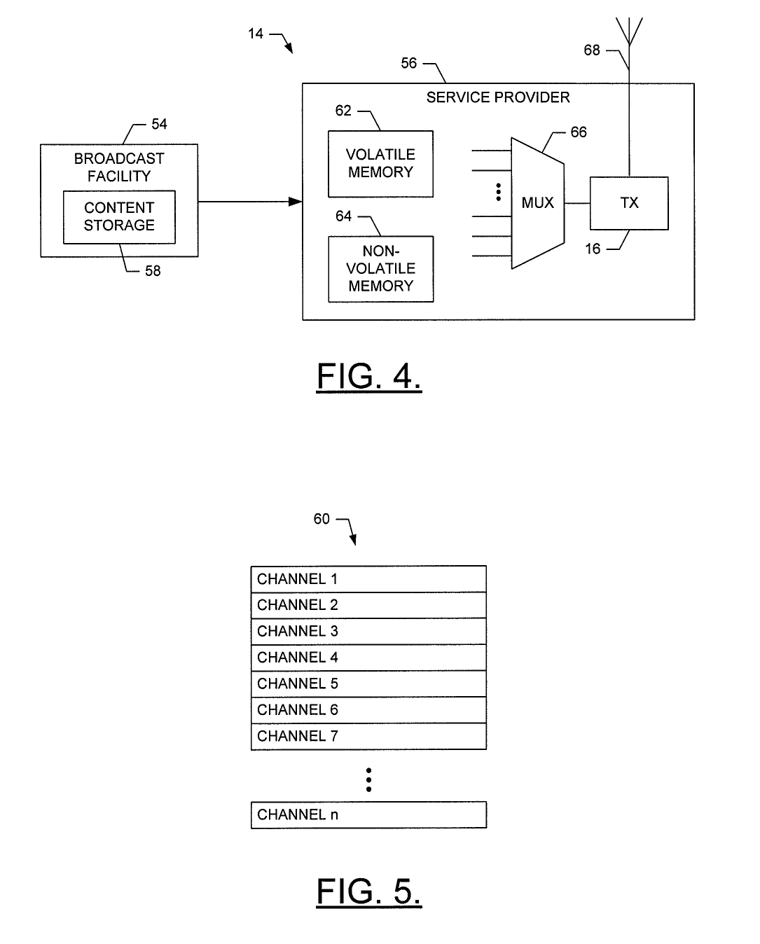

Reference is now made to FIG. 4, which illustrates a functional block diagram of the digital broadcaster 14 of one embodiment of the present invention. As shown, the digital broadcaster can include one or more broadcast facilities 54 capable of providing content to a digital broadcast service provider 56 for broadcast. Each broadcast facility can include volatile memory, such as volatile Random Access Memory (RAM) including a cache area for the temporary storage of data. The digital broadcaster can also include non-volatile memory, which can be embedded and/or may be removable. The non-volatile memory can additionally or alternatively comprise an EEPROM, flash memory, hard disk or the like. The memories can include, for example a content storage 58 for storing broadcast content, such as one or more channels of commercial and/or non-commercial broadcast television and/or radio content. In addition to including piece(s) of content stored in content storage, however, it should be understood that the broadcast facilities may also provide one or more channels of live broadcast content, such as news, sporting events or the like, which are incapable of being pre-stored in the content storage for any appreciable amount of time. Further, for example, the broadcast facilities may provide channels including pre-stored and live broadcast content, such as broadcast news content that can include one or more pre-stored news stories as well as live news anchor narratives for the news stories. Irrespective of whether the content is pre-stored or live, however, the digital broadcaster of one exemplary embodiment may broadcast such content over n ordered channels, as shown in the channel listing 60 of FIG. 5.

Like the digital broadcast receiving terminal 18, the digital broadcast service provider 56 of the digital broadcaster 14 can include volatile memory 62, such as volatile Random Access Memory (RAM) including a cache area for the temporary storage of data. The digital broadcaster can also include non-volatile memory 64, which can be embedded and/or may be removable. The non-volatile memory can additionally or alternatively comprise an EEPROM, flash memory, hard disk or the like. The memories can store any of a number of pieces of information, content and data, used by the digital broadcaster to implement the functions of the digital broadcaster. For example, as indicated above, the memories can store content, such as content for a television channel and other content for a number of other television, radio and/or data channels, as such can be provided by the broadcast facilities 54.

The digital broadcast service provider 56 of the digital broadcaster 14 can also include a multiplexer 66, which can be capable of multiplexing content for a number of television, radio and/or data channels, such as those provided by the broadcast facilities 54. In this regard, the multiplexer can be capable of multiplexing content for broadcast in accordance with a schedule 60 stored in content storage 58 of a broadcast facility. The multiplexer can then feed the resulting signal into a TX 16, which can be separate from the digital broadcaster, or more particularly the digital broadcast service provider, as shown in FIG. 1, or incorporated within the digital broadcaster, as shown in FIG. 4.

Irrespective of where the TX 16 is located relative to the digital broadcaster 14, the TX can receive the signal from the multiplexer 66 for encryption, modulation, amplification and/or transmission, such as via an antenna 68. For example, the digital broadcaster can be capable of directly or indirectly transmitting content to a digital broadcast receiving terminal 18 and/or a terminal 10, such as in accordance with a digital broadcasting technique, such as DVB-T. In this regard, the digital broadcaster can be capable of transmitting broadcast content, including one or more pieces of broadcast content stored by the content storage 58 of the broadcast facility 54, and/or one or more pieces of live broadcast content, in accordance with the times specified for the respective pieces of content in a schedule 60 stored by the content storage 58. For information on DVB-T, see European Telecommunications Standards Institute (ETSI) Standard EN 300 744, entitled: Digital Video Broadcasting (DVB): Framing Structure, Channel Coding and Modulation for Digital Terrestrial Television, v.1.1.2 (1997) and related specifications, the contents of which are hereby incorporated by reference in their entirety.

In accordance with a number of digital broadcasting techniques, such as DVB-H, Internet Protocol (IP) Datacasting (IPDC) can be utilized to provide audio, video and/or other content to terminals 10. In this regard, the digital broadcaster 14 can be capable of providing IP datacasting content to the terminal utilizing a digital broadcasting technique. DVB-H, for example, uses MPEG-2 transport streams, and as such, IP data can be encapsulated into DVB transmission signals sent from the digital broadcaster, or more particularly the TX 16. Data streams including IP datagrams can be supplied from several sources, and can be encapsulated by an IP encapsulator (not shown). The IP encapsulator, in turn, can feed the encapsulated IP data streams into the digital broadcasting (e.g., DVB-H) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, may be uni-directional in nature. In this regard, IP packets containing the data can be embedded in multi-protocol encapsulation (MPE) sections that are transported within transport stream packets.

In addition to the IP packets, the MPE sections can also include forward error correction (FEC) information and time slicing information. By including information such as time slicing information, data can be conveyed discontinuously with the receiver (e.g., terminal 10), being capable of saving battery power by switching off when no data is being transmitted to the receiver. In other terms, in accordance with one time slicing technique, instead of using the current default method of continuous digital broadcasting (e.g., DVB-T) transmission, a time division multiplex-type of allocation technique can be employed (see, e.g., DVB-H standard). With such an approach, then, services can be provided in bursts, allowing a receiver to power down when the receiver is not receiving data, and allowing the receiver to power up to receive data packets, as necessary.

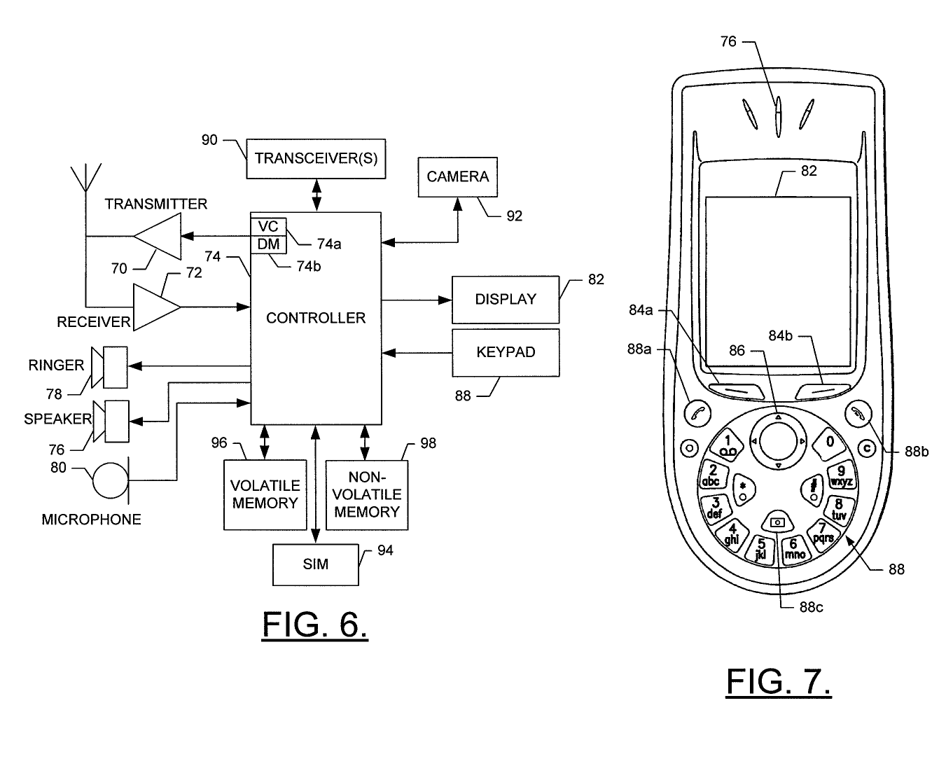

FIGS. 6 and 7 illustrate a functional block diagram and a schematic diagram, respectively, of a mobile station that may operate as a terminal 10, according to exemplary embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes various means for performing one or more functions in accordance with exemplary embodiments of the present invention, including those more particularly shown and described herein. It should be understood, however, that the mobile station may include alternative means for performing one or more like functions, without departing from the spirit and scope of the present invention. More particularly, for example, as shown in FIG. 6, the mobile station includes a transmitter 70, a receiver 72, and a controller 74 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, IS-95 (CDMA) or the like. Also, for example, the mobile station may be capable of operating in accordance with 2.5G wireless communication protocols GPRS, Enhanced Data GSM Environment (EDGE), or the like. The mobile station can additionally or alternatively be capable of operating in accordance with any of a number of different digital broadcasting techniques, such as the DVB technique (e.g., DVB-T, ETSI Standard EN 300 744). The mobile station can also be capable of operating in accordance with any of a number of different broadcast and/or multicast techniques, such as the MBMS technique (e.g., 3GPP TS 22.146). Further, the mobile station can be capable of operating in accordance with ISDB-T, DAB, ATSC techniques or the like. Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 74 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 74a, and may include an internal data modem (DM) 74b. Further, the controller may include the functionality to operate one or more software applications, which may be stored in memory.

The mobile station also comprises a user interface including a conventional earphone or speaker 76, a ringer 78, a microphone 80, a display 82, and a user input interface, all of which are coupled to the controller 74. The display can present any of a number of different displays, such as data and menus. The display can also display areas for softkey functions that can be actuated by depressing softkeys 84a and 84b, respectively. The user input interface can include directional keys (←, ↑, →, ↓) 86 such as for scrolling through menu items featured on the display and/or directing performance of other directional actions. The directional keys can be implemented in a number of different manners, such as with separate directional keys or a single element, such as a rolling cylinder, ball or the like, capable of performing the functions of such directional keys. In addition to the directional keys, the user input interface can include other elements allowing the mobile station to receive data, such as a keypad 88, a touch display (not shown) or other input device.

In embodiments including a keypad 88, the keypad includes the conventional numeric (0-9) and related keys (#, *), and other keys used for operating the mobile station. The other keys can comprise keys preprogrammed for actuating the mobile station to perform particular functions, such as a key 88a for initiating an outgoing call and/or answering an incoming call, a key 88b for terminating an established call, and/or a key 88c for driving the image capture device to capture an image. Although a number of keys are shown and described herein as comprising hard keys on a keypad, it should be understood that any one or more of such keys may equally comprise softkeys actuating respective softkey functions, without departing from the spirit and scope of exemplary embodiments of the present invention. Similarly, keys shown and described as comprising softkeys actuating softkey functions may equally comprise respective hard keys, without departing from the spirit and scope of exemplary embodiments of the present invention.

The mobile station 10 can also include one or more means, such as one or more transmitters, receivers and/or transceivers 90 for sharing and/or obtaining data. For example, the mobile station can include a short-range radio frequency (RF) transceiver or interrogator so that data can be shared with and/or obtained from electronic devices in accordance with RF techniques. The mobile station can additionally, or alternatively, include other short-range transceivers, such as, for example an infrared (IR) transceiver, and/or a Bluetooth (BT) transceiver operating using Bluetooth brand wireless technology developed by the Bluetooth Special Interest Group. The mobile station can therefore additionally or alternatively be capable of transmitting data to and/or receiving data from electronic devices in accordance with such techniques. In addition, the mobile station can include an image capture element 92, such as a digital camera, charge coupled device (CCD), optical scanner or the like, such that the mobile station can obtain image data in accordance with any of a number of different electronic imaging techniques. Although not shown, the mobile station can additionally or alternatively be capable of transmitting and/or receiving data from electronic devices according to a number of different wireless networking techniques, including WLAN, WiMAX, UWB techniques or the like.

The mobile station can further include memory, such as a subscriber identity module (SIM) 94, a removable user identity module (R-UIM) or the like, which may store information elements related to a mobile subscriber. In addition to the SIM, the mobile station can include other memory. In this regard, like the digital broadcast receiving terminal 18 and the digital broadcaster 14, the mobile station can include volatile memory 96. Also, again like the digital broadcast receiving terminal and the digital broadcaster, the mobile station can include other non-volatile memory 98, which can be embedded and/or may be removable. For example, the other non-volatile memory can comprise embedded or removable multimedia memory cards (MMC's), Memory Sticks manufactured by Sony Corporation, EEPROM, flash memory, hard disk or the like.

The memories 94, 96, 98 can store any of a number of pieces of information, and data, used by the mobile station to implement the functions of the mobile station. For example, the memories can store an identifier, such as an international mobile equipment identification (IMEI) code, capable of uniquely identifying the mobile station. The memories can also store one or more client applications, such as a conventional text viewer, audio player, video player, multimedia viewer or the like, for consuming content for one or more television, radio and/or data channels. As indicated above, although the client application(s) may comprise software operated by the respective entities, one or more such applications may alternatively comprise firmware or hardware.

As indicated in the background section, when a user operates a terminal 10 to consume or otherwise view broadcast content for a particular channel, the user may desire to direct their terminal to perform one or more other functions, such as to place or answer a call. And although techniques have been developed whereby the user direct the terminal to perform other functions while recoding broadcast content for later consumption, a number of those techniques may require the user to navigate through a series of menus to direct the terminal to record the desired content. The terminal of exemplary embodiments of the present invention is therefore capable of being configured such that one or more keys, such as one or more softkeys keys 84a and 84b (with respect to one or more softkey functions) and/or keypad 88 keys, may be preprogrammed for performing one or more functions of the terminal, and also configured for recording broadcast content. In this regard, one or more such keys, preprogrammed for actuating the mobile station to perform one or more predefined functions, may also be configured for actuating a client application, such as a mobile TV application, to record content for a selected channel x of a plurality of channels. In such instances, the respective key(s) may be configured to record content for a selected channel based upon the client application currently receiving and consuming (e.g., playing) content for the respective channel.

Thus, for example, presume that while a terminal user is operating the terminal 10 to receive and consume content for a selected channel x, the terminal receives an incoming voice call. In such an instance, the terminal can be configured to perform a preprogrammed function associated with the respective key (e.g., answering an incoming call). In addition, the terminal can be configured such that, when the user depresses key 88a of the terminal keypad 88 while the client application is receiving and consuming content for a selected channel, the terminal is further actuated to begin recording content for the selected channel. Thus, instead of requiring the user to choose between consuming the broadcast content and answering the incoming voice call, or requiring the user to navigate through a series of menus, the user may quickly answer an incoming call to perform other functions of the terminal while recording the broadcast content for later consumption.

In another more general example, presume that while the user is operating the terminal 10 to receive and consume content for a selected channel x, the user desires to direct the terminal to perform other functions, but also desires to continue consumption content for the selected channel, just at a later time. In such instance, the terminal can be configured such that depressing a keypad key 88c actuates the terminal to drive the image capture device to capture an image. To enable quick recording of a currently selected channel x, however, the same key 88c can be configured such that depressing and holding the respective key (e.g., for two-three seconds) while the client application is receiving and consuming content for a selected channel actuates the terminal to begin recording content for the selected channel.

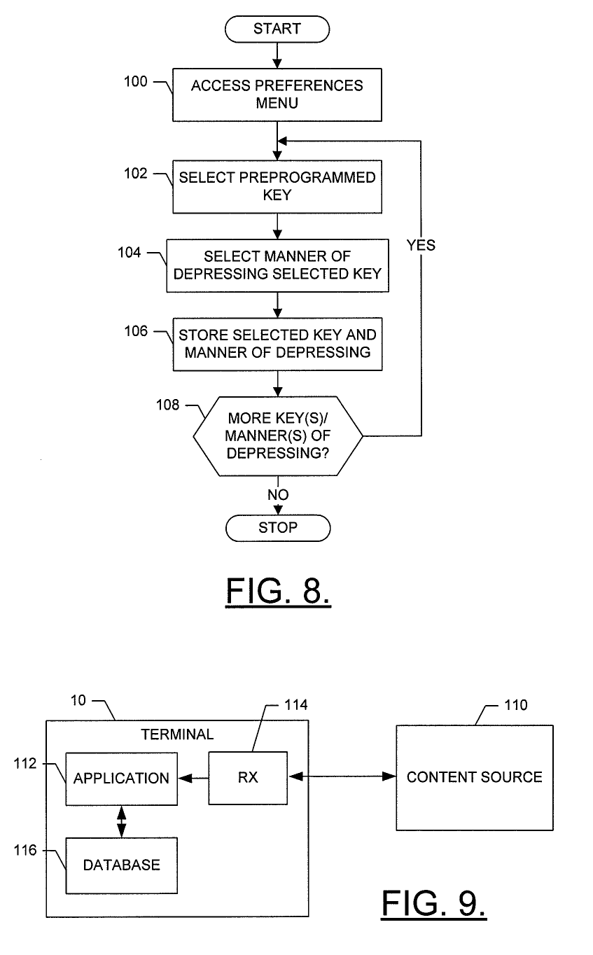

To improve the speed at which a client application can be actuated to record broadcast content for a selected channel, one or more preprogrammed keys (softkeys for one or more softkey functions and/or hard keypad keys) of the mobile station can be configured to additionally actuate the client application. The key(s) can be configured in any one of a number of manners but, according to one exemplary embodiment, referring now to FIG. 8, the key(s) can be configured by a terminal user accessing a preference menu, as shown in block 100. Then, from the preference menu, the user can select a key configuration menu. The user can then select a desired key, and thereafter select the manner of depressing the key (e.g., depress, double-depress, depress and hold, etc.) to actuate the client application, as shown in blocks 102 and 104. For example, the user can select key 88a and depressing that key as the manner of actuating the client application, and/or select key 88c and depressing and holding that key as the manner of actuating the client application. In this regard, the manner of depressing the selected key to actuate the client application recording content can be the same as or different from that to actuate the terminal to perform the preprogrammed function of the respective key. When the manners of depressing the selected key are the same, depressing the selected key may actuate the client application to perform its recording function in addition to the terminal performing the preprogrammed function. When the manners of depressing the selected key are different, however, the selected key may be depressed in accordance with those different manners to separately actuate the client application to perform its recording function, or actuate the terminal to perform the preprogrammed function.

After selecting a key and the manner of depressing the key to actuate the client application to record broadcast content for a selected channel, the respective key and manner of depressing can be stored in a preference table held in memory, such as in non-volatile memory, as shown in block 106. After storing the selected key and manner of depressing, the terminal user can configure the other keys and/or manners of depressing keys for also actuating the client application to record broadcast content, if so desired, as illustrated in block 108. If the user desires to configure other keys and/or manners of depressing the same or other keys, the user can repeat the process by selecting another key or another manner of selecting an already configured key.

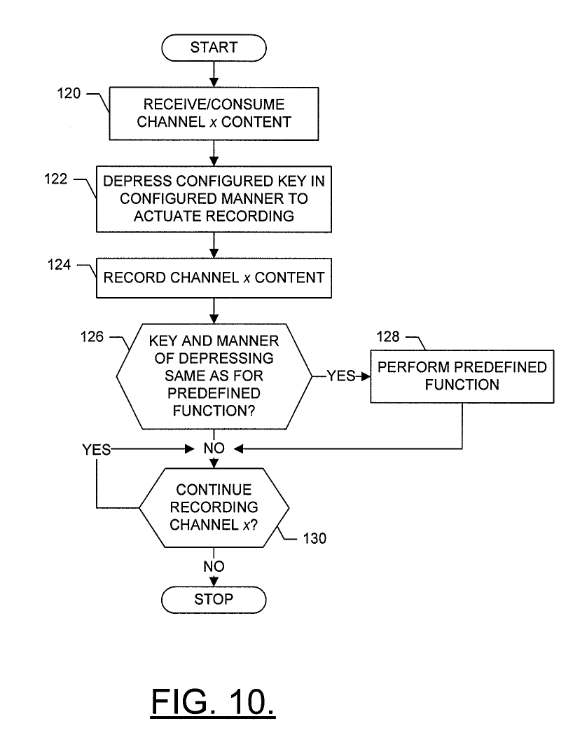

After storing the keys and manners of depressing those keys to actuate the client application to record broadcast content for a selected channel x, the client application can be actuated to begin receiving and consuming broadcast content. Reference is now drawn to FIGS. 9 and 10, which illustrate a functional block diagram and flowchart, respectively, of a terminal 10 and method of recording broadcast content, in accordance with one exemplary embodiment of the present invention. More particularly, FIG. 9 illustrates a functional block diagram of a terminal receiving, from a content source 100, broadcast content for one or more channels of a set of channels. Whereas the content source described below comprises a digital broadcaster 14, it should be understood that the content source can comprise any of a number of different sources (e.g., digital broadcast receiving terminal 18, etc.) capable of broadcasting content in accordance with exemplary embodiments of the present invention. Also, as described below, the terminal described herein with respect to the embodiment of FIGS. 9 and 10 may comprise terminal 10. It should be understood, however, that the terminal can equally comprise a digital broadcast receiving terminal, without departing from the spirit and scope of the present invention. Further, although the broadcast content may be described as being that for one or more television and/or radio channels. It should be understood that the broadcast content can comprise any of a number of different types of content, and can be received at the terminal in accordance with any of a number of different wireline and/or wireless transfer techniques.

As shown in FIG. 9, the terminal 10 can operate a client application 112, such as a mobile TV application, for receiving and consuming (e.g., playing) content for a selected channel x of a plurality of ordered channels. After executing or otherwise activating the client application, a terminal user can direct the client application to receive and consume content for a selected channel, as shown in block 120 of FIG. 10. For example, the client application can be configured to present a user interface (UI) including a channel listing 60 from which the user can select a desired channel. Irrespective of how the client application is directed to receive and consume content for a selected channel x, the application thereafter receives the selected channel content from a content source 110 via a receiver (RX) 114 of the terminal. The receiver can receive the selected channel content from the content source in accordance with any of a number of different transfer techniques such as, for example, techniques specified by DVB, GPRS, EDGE or the like. And the selected channel content can comprise content stored by the content storage 58 maintained by a broadcast facility 54 providing such content to the digital broadcaster 14.

As the client application 112 receives and consumes content for the selected channel x, the terminal user may decide to record content for the selected channel, alone or in conjunction with performing another function of the terminal 10. In such instances, the terminal user may depress a configured key (softkey for a softkey function and/or hard keypad key) in a configured manner to thereby direct the client application to enter a recording mode and to record broadcast content for the selected channel x (perform a first function), as shown in blocks 122 and 124. For example, if so configured, the terminal user may depress key 88a, or depress and hold key 88c, to direct the client application to enter the recording mode and record broadcast content for the selected channel x. The client application can then operate to record content for the selected channel x, and store the recorded content in a database 116 (e.g., within memory 30, volatile memory 48, non-volatile memory 50, volatile memory 96, non-volatile memory 98, etc.).

Before, after or as the client application 112 enters the recording mode to record broadcast content for the selected channel, the terminal may be actuated to perform one or more other functions (second and subsequent functions). In this regard, when the terminal is configured to perform a predefined function in response to depressing the respective key in the same manner as that configured for actuating the client application, the terminal may be actuated to perform the respective function before, after or as the client application enters the recording mode, as shown in blocks 126 and 128. As explained above, such other functions can include, for example, initiating or answering a voice call when the user depresses key 88a of the terminal keypad 88.

As shown in block 130, the client application 112 can continue recording content for the selected channel x, such as until one or more of a number of different events occur. For example, the client application can continue recording content for the selected channel until the size of the recorded content in the database 116 exceeds a first threshold, and/or until the available portion of the database decreases below a second threshold. Additionally or alternatively, for example, the client application can continue recording content for the selected channel until a program including the respective content ends.

Further, for example, in various instances, such as when the client application 112 is actuated to record content as the terminal 10 is actuated to perform another function, the terminal display 82 may at least temporarily cease presenting the respective broadcast content. In such instances (or in other instances), as the client application starts recording content for the selected channel, the client application can initialize a recording timeout for the respective channel. The client application can then continue recording content for the selected channel until the recording timeout expires, where the recording timeout may or may not be reinitialized at one or more instances during the recording. In this regard, the recording timeout can be reinitialized or otherwise reset in any of a number of other manners, such as in response to the display returning to presenting the respective broadcast content, and/or by notifying the terminal user of the impending expiration of a recording timeout and receiving direction from the user to reset the respective recording timeout.

At one or more instances during and/or after recording content for the selected channel x, the user may desire to experience the recorded content such as by directing the client application 112 to consume the recorded content. In such instances, the client application can proceed to consume the recorded content. If the user directs the client application to consume the recorded content before the client application has ceased recording the content, the client application may respond in a number of different manners. For example, the client application may consume the recorded content in the same order in which the client application recorded the content, starting from the beginning of the recording, and continue to record content for the respective channel.

As shown and described herein, the client application 112 can be actuated to record content for a selected channel x, and store the recorded content in a database 116. It should be understood, however, that in various instances the client application may offload storage of the recorded content, or both recording and storage of the recorded content. For example, before, after or as the client application records content for the selected channel, the client application can initiate communication with a set top box (i.e., DB receiving terminal 18) to thereby direct the set top box to record and store content for the selected channel. In such instances, the set top box can receive and record content for the selected channel via the terminal or, if so desired and so configured, independent of the terminal. Any portion of the content already recorded and stored in the database of the terminal, then, may be maintained in the database or transferred by the terminal to the set top box for storage with the remaining portion recorded by the set top box. In another exemplary instance, the client application may record the content, and thereafter transfer the recorded content from the database to the set top box, such as for consumption thereby.

It should also be understood that, as content of one or more channels may be recorded and stored in the database 116, the channel(s) of content may be organized in the database in a library of content. The client application 112 can therefore be configured to present, upon request by the terminal user or at a number of other instances, at least a portion of the library. The user can then select one or more pieces of recorded content to thereby direct the client application to consume the selected content from database. In addition, the pieces of content may be configured to have associated metadata including one or more sortable characteristics of the content, such as a title, author, date and/or time of broadcast and/or recording, or the like.

Further, as explained above keys of the terminal preprogrammed for one or more predefined functions can be configured to actuate the client application 112 to record content. It should be understood, however, that although being described as being preprogrammed for certain functions, and configured for other functions, the terminal 10 may be preprogrammed for the configured functions, and/or configured for the preprogrammed functions without departing from the spirit and scope of the present invention. Thus, for example, one or more keys of the terminal may be preprogrammed for actuating the client application to record content, and also configured for performing one or more other functions of the terminal. Also, for example, one or more keys may be preprogrammed for both actuating the client application and for performing one or more other functions. And one or more keys may be configured for both actuating the client application and for performing one or more other functions.

According to one exemplary aspect of the present invention, the functions performed by one or more of the entities of the system, such as the terminal 10, digital broadcaster 14 and/or digital broadcast receiving terminal 18, may be performed by various means, such as hardware and/or firmware, including those described above, alone and/or under control of a computer program product (e.g., client application 112, etc.). The computer program product for performing one or more functions of exemplary embodiments of the present invention includes a computer-readable storage medium, such as the non-volatile storage medium, and software including computer-readable program code portions, such as a series of computer instructions, embodied in the computer-readable storage medium.

In this regard, FIGS. 8, 9 and 10, are functional block diagrams and flowcharts, respectively, of systems, methods and program products according to exemplary embodiments of the present invention. It will be understood that each block or step of the functional block diagrams and flowcharts, and combinations of blocks in the functional block diagrams and flowcharts, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the block(s) or step(s) of the functional block diagrams and flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the functional block diagrams and flowcharts. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the functional block diagrams and flowcharts.

Accordingly, blocks or steps of the flowcharts support combinations of means for performing the specified functions, combinations of steps for performing the specified functions and program instruction means for performing the specified functions. It will also be understood that one or more blocks or steps of the functional block diagrams and flowcharts, and combinations of blocks or steps in the functional block diagrams and flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A terminal for recording broadcast content, the terminal comprising:
a user input interface including a key configured for performing a first function in response to a first manner of depressing the key, the same key also being preprogrammed for performing a second, different function in response to a second manner of depressing the key, the first function comprising recording content for the selected channel; and
a processor configured for receiving broadcast content for a selected channel, wherein the processor is also configured for recording content for the selected channel in response to a user depressing the key of the user input interface in the first manner.

2. A terminal according to claim 1, wherein the processor is further configured for performing the second function in response to the user depressing the key of the user input interface in the second manner.

3. A terminal according to claim 2, wherein the first manner of depressing the key is different from the second manner of depressing the key.

4. A terminal according to claim 1, wherein the first manner of depressing the key is the same as the second manner of depressing the key, and wherein the processor is further configured for performing the second function in response to the user depressing the key of the user input interface in the first manner.

5. A terminal according to claim 4, wherein the second function comprises placing or answering a call at the terminal.

6. A terminal according to claim 4, wherein the processor is further configured for consuming the broadcast content as the broadcast content is received, and wherein the processor is configured for at least temporarily ceasing consumption of the broadcast content as the second function is performed.

7. A terminal according to claim 1, wherein the processor is configured for recording content including directing a remote network entity to record content for the selected channel.

8. A terminal for recording broadcast content, the terminal comprising:
a first means for receiving broadcast content for a selected channel, the terminal including a user input interface including a key configured for performing a first function in response to a first manner of depressing the key, the same key also being preprogrammed for performing a second, different function in response to a second manner of depressing the key, the first function comprising recording content for the selected channel; and
a second means for recording content for the selected channel in response to a user depressing the key of the user input interface in the first manner.

9. A computer program product according to claim 8, wherein the computer program product further comprises:
a third means for performing the second function in response to the user depressing the key of the user input interface in the second manner.

10. A computer program product according to claim 9, wherein the first manner of depressing the key is different from the second manner of depressing the key.

11. A computer program product according to claim 8, wherein the first manner of depressing the key is the same as the second manner of depressing the key, and wherein the computer program product further comprises a third means for performing the second function in response to depressing the key of the user input interface in the first manner.

12. A computer program product according to claim 11, wherein the second function comprises placing or answering a call at the terminal.

13. A computer program product according to claim 11 further comprising:
a fourth means for consuming the broadcast content as the broadcast content is received, wherein the fourth means is adapted to consume the broadcast content by at least temporarily ceasing consumption of the broadcast content as the second function is performed.

14. A computer program product according to claim 8, wherein the second means is adapted to direct a remote network entity to record content for the selected channel.

15. A user interface of a terminal, the user interface comprising:
a key configured for directing the terminal to perform a first function in response to a first manner of depressing the key, the same key also being preprogrammed for directing the terminal to perform a second, different function in response to a second manner of depressing the key, the first function comprising recording content for the selected channel,
wherein the key is configured for directing the terminal to record content for a selected channel for which the terminal is receiving broadcast content, the terminal being directed to record the content in response to a user depressing the key of the user input interface in the first manner.

16. A user interface according to claim 15, wherein the key is further configured for directing the terminal to perform the second function in response to the user depressing the key of the user input interface in the second manner.

17. A user interface according to claim 16, wherein the first manner of depressing the key is different from the second manner of depressing the key.

18. A user interface according to claim 15, wherein the first manner of depressing the key is the same as the second manner of depressing the key, and wherein the key is further configured for directing the terminal to perform the second function in response to the user depressing the key of the user input interface in the first manner.

19. A user interface according to claim 4, wherein the second function comprises placing or answering a call at the terminal.

20. A user interface according to claim 4, wherein the terminal is configured for consuming the broadcast content as the broadcast content is received, and wherein the key is configured for directing the terminal to at least temporarily ceasing consumption of the broadcast content as the second function is performed.

21. A user interface according to claim 15, wherein the key is configured for directing the terminal to record content including directing a remote network entity to record content for the selected channel.

22. A method for recording broadcast content, the method being implemented at a terminal and comprising:
receiving broadcast content for a selected channel, the terminal including a user input interface including a key configured for performing a first function in response to a first manner of depressing the key, the same key also being preprogrammed for performing a second, different function in response to a second manner of depressing the key, the first function comprising recording content for the selected channel;
depressing the key of the user input interface in the first manner; and in response thereto,
recording content for the selected channel.

23. A method according to claim 22, wherein the method further comprises:
depressing the key of the user input interface in the second manner; and in response thereto,
performing the second function.

24. A method according to claim 23, wherein the first manner of depressing the key is different from the second manner of depressing the key.

25. A method according to claim 22, wherein the first manner of depressing the key is the same as the second manner of depressing the key, and wherein the method further comprises performing the second function in response to depressing the key of the user input interface in the first manner.

26. A method according to claim 25, wherein the second function comprises placing or answering a call at the terminal.

27. A method according to claim 25 further comprising:
consuming the broadcast content as the broadcast content is received, wherein consuming the broadcast content includes at least temporarily ceasing consumption of the broadcast content as the second function is performed.

28. A method according to claim 22, wherein recording content comprises directing a remote network entity to record content for the selected channel.

29. A computer program product for recording broadcast content, the computer program product being implemented at a terminal and comprising at least one computer-readable storage medium having computer-readable program code portions stored therein, the computer-readable program code portions comprising:
a first executable portion for receiving broadcast content for a selected channel, the terminal including a user input interface including a key configured for performing a first function in response to a first manner of depressing the key, the same key also being preprogrammed for performing a second, different function in response to a second manner of depressing the key, the first function comprising recording content for the selected channel; and
a second executable portion for recording content for the selected channel in response to a user depressing the key of the user input interface in the first manner.

30. A computer program product according to claim 29, wherein the computer program product further comprises:
a third executable portion for performing the second function in response to the user depressing the key of the user input interface in the second manner.

31. A computer program product according to claim 30, wherein the first manner of depressing the key is different from the second manner of depressing the key.

32. A computer program product according to claim 29, wherein the first manner of depressing the key is the same as the second manner of depressing the key, and wherein the computer program product further comprises a third executable portion for performing the second function in response to depressing the key of the user input interface in the first manner.

33. A computer program product according to claim 32, wherein the second function comprises placing or answering a call at the terminal.

34. A computer program product according to claim 32 further comprising:
a fourth executable portion for consuming the broadcast content as the broadcast content is received, wherein the fourth executable portion is adapted to consume the broadcast content by at least temporarily ceasing consumption of the broadcast content as the second function is performed.

35. A computer program product according to claim 29, wherein the second executable portion is adapted to direct a remote network entity to record content for the selected channel.
